(19) United States
(12) Patent Application Publication
(10) Pub. No.: US 2008/0053217 A1
(43) Pub. Date: Mar. 6, 2008

(54) Oil level detection system of internal combustion engine

(75) Inventors: Masaki Nishio, Wako-shi (JP); Kouji Okayasu, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD.

(21) Appl. No.: 11/896,342

(22) Filed: Aug. 31, 2007

(30) Foreign Application Priority Data
Aug. 31, 2006 (JP) JP2006-236935

(51) Int. Cl. G01F 23/00

(52) U.S. Cl. 73/291; 701/101

(57) ABSTRACT

In an oil level detection system of an internal combustion engine having a filter to capture particulates in exhaust gas that is burned off by fuel supplied by post injection to be regenerated and having an oil level sensor installed in an oil pan, it is determined whether the engine is under a long idling state and if so, an estimated value of the engine oil level is calculated by correcting output of the oil level sensor by an evaporation amount correction factor. Then, it is determined whether the level of the engine oil is sufficient by comparing the estimated value with a threshold value. With this, it becomes possible to detect the oil shortage without delay.

### BACKGROUND OF THE INVENTION

1. Field of the Invention

The present invention relates to an oil level detection system of an internal combustion engine.

2. Description of the Related Art

One example of a system for detecting the level of engine oil in an oil pan or sump of an internal combustion engine can be found in Japanese Laid-Open Patent Application No. 2004-150374. This system has a sensor for detecting the level of engine oil in the oil pan of the internal combustion engine mounted on a vehicle, and is configured to enhance the accuracy of oil level detection by determining whether a place on which the vehicle runs or parks is a bumpy road or similar road that could affect the detection accuracy, and by prohibiting the oil level detection when the result is affirmative.

The engine of this prior art system is a spark ignition engine using gasoline fuel. If the engine is a diesel engine, it has a DPF (Diesel Particulate Filter) installed in the exhaust system to remove fine particulates or particulate matters (PMs) from the exhaust gas in microporous trap. As the captured fine particulates increase, the filter progressively clogs and its ability to capture the particulates drops. The practice is accordingly to conduct a post fuel injection at or near the exhaust stroke to burn off the particulates deposited on the DPF and regenerate it.

A part of fuel supplied by the post injection drops below through gaps between the cylinder wall and piston and collects in the oil pan. The fuel mixes with engine oil (lubricant) pooled there and dilute it. Although the level of engine oil increases apparently by such a dilution, the mixed fuel will evaporate shortly. This oil dilution may sometimes delay the detection of oil shortage and hence, damage the engine. Evaporation of mixed fuel in the engine oil is promoted when the engine runs at idle speed consecutively for a long period of time.

### SUMMARY OF THE INVENTION

An object of the present invention is to solve the problem and to provide an oil level detection system of an internal combustion engine in which post fuel injection is made at or near the exhaust stroke to burn off particulates deposited on a filter to regenerate the filter, that can detect the oil shortage without delay even when the engine runs at idle speed consecutively for a long period of time.

The present invention achieves the object by providing a system for detecting level of engine oil in an oil pan of an internal combustion engine having a filter to capture particulates in exhaust gas that is burned off by fuel supplied by post injection to be regenerated, comprising: an oil level sensor installed in the oil pan and adapted to produce an output indicative of the engine oil level; a long idling state determiner that determines whether the engine is under a long idling state in which an idling state continues for a predetermined period of time or more; an estimated engine oil level calculator that calculates an estimated value of the engine oil level under the long idling state by correcting the output of the oil level sensor by an evaporation amount correction factor, when the engine is determined to be under the long idling state; and an engine oil level discriminator that discriminates whether the level of the engine oil is sufficient based on the calculated estimated value of the engine oil level.

### BRIEF DESCRIPTION OF THE DRAWINGS

The above and other objects and advantages of the invention will be more apparent from the following description and drawings in which:

FIG. 1 is a schematic drawing showing the overall configuration of an oil level detection system of an internal combustion engine according to an embodiment of the invention; and

FIG. 2 is a flowchart showing the operation of the system illustrated in FIG.

### DETAILED DESCRIPTION OF THE PREFERRED EMBODIMENT

An oil level detection system of an internal combustion engine according to an embodiment of the present invention will now be explained with reference to the attached drawings.

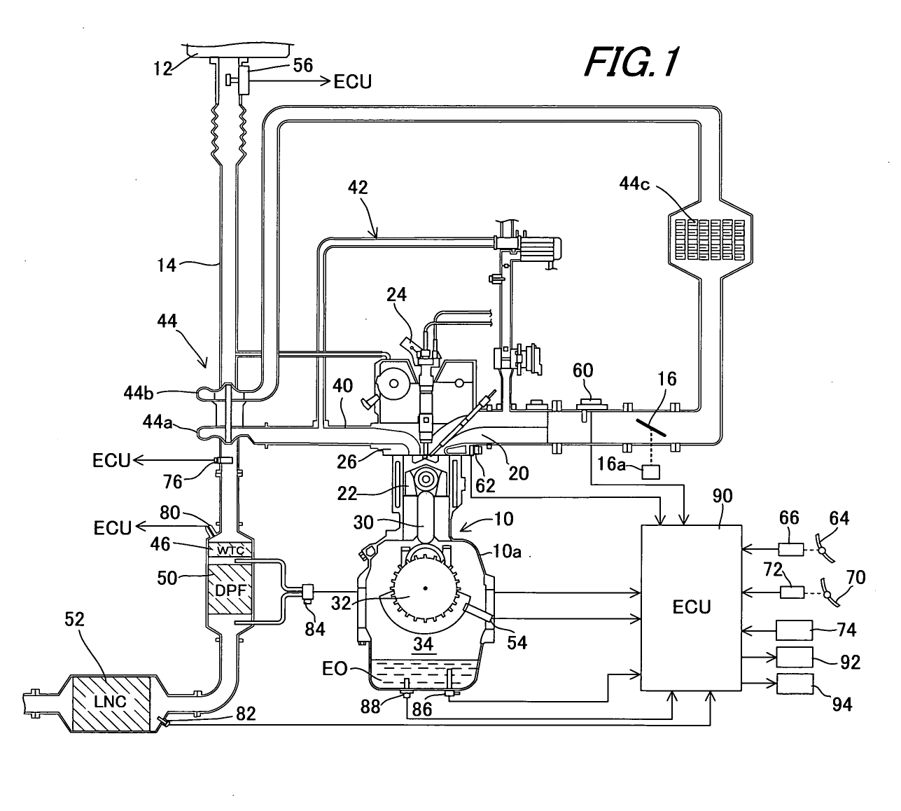

FIG. 1 is a schematic drawing showing the overall configuration of the oil level detection system of an internal combustion engine according to the embodiment.

In FIG. 1, reference numeral 10 designates a four-cylinder internal combustion engine, more specifically diesel engine (compression-ignition engine), and reference numeral 10a indicates a main body of the engine 10. In FIG. 1, only one of four cylinders is shown.

In the engine 10, air sucked in through an air cleaner (partially shown) 12 flows through an intake pipe 14 downstream of the air cleaner 12. An intake shutter 16 is installed at the intake pipe 14 at a location close to the engine main body 10a. The intake shutter 16 is connected to an actuator 16a and moves to a closing direction to regulate or decrease the air flow when the actuator 16a is driven by an Electronic Control Unit (hereinafter referred to as “ECU”; explained later).

The sucked air flows through the intake pipe 14 and an intake manifold 20 connected to the intake pipe 14 and arrives at the individual cylinders to be drawn into their combustion chambers when the associated intake valve (not shown) opens and the associated piston 22 descends. The inspired air is compressed and reaches a high temperature when the piston 22 ascends.

Fuel (diesel fuel or diesel oil) contained in a fuel tank (not shown) is pumped and pressurized by a fuel pump to flow through a common rail (not shown) and is supplied to four fuel injectors 24 each provided at a location facing to the combustion chamber of the associated cylinder.

Pressurized fuel is injected into the combustion chamber when the associated injector 24 is opened by the ECU. The injected fuel spontaneously ignites and burns upon coming in contact with the compressed, high-temperature air. As a result, the piston 22 is driven downward and thereafter ascends to discharge the exhaust gas into an exhaust manifold 26 upon opening of an associated exhaust valve (not shown).

The up-and-down motion of the piston 22 is transmitted, via a connecting rod 30, to a crankshaft 32 to rotate it. The rotation of the crankshaft 32 is transmitted to driven wheels (not shown) through a manual transmission (not shown).

An oil pan (or sump) 34 in a bath-shaped reservoir is formed at the bottom of the crankcase of the engine main body 10a where engine oil EO is pooled. The engine oil EO is pumped by a gear pump to forcibly feed to all bearing points, while sliding parts are lubricated by splash lubrication and oil mist. After flowing through the bearing points and sliding parts, the engine oil EO returns to the oil pan 34 through returning paths (not shown).

The exhaust gas discharged from the combustion chamber by the piston 22 flows into the exhaust manifold 26 and then flows through an exhaust pipe 40. An Exhaust Gas Recirculation pipe 42 is connected to the exhaust pipe 40 at one end and is connected to the air intake system at the other end.

Reference numeral 44 indicates a turbocharger and its air turbine 44a is installed in the exhaust pipe 42 at a location downstream of the point where the EGR pipe 42 is connected. The turbine 44a is driven by the exhaust gas and drives an air compressor 44b installed in the intake pipe 14 and mechanically connected to the turbine 44a to compress the air inducted for combustion. Reference numeral 44c indicates an intercooler.

A three-way catalytic converter (shown in the figure as “TWC”) 46 is installed in the exhaust pipe 40 at a position downstream of the turbocharger 44 to reduce all three pollutants of HC, CO and NOx in the exhaust gas.

A DPF (Diesel Particulate Filter; hereinafter referred to as “filter”) 50 is installed downstream of the catalytic converter 46. The filter 50 comprises a ceramic honeycomb filter internally provided with exhaust gas passages whose upstream ends are closed and downstream ends are opened arranged alternately with exhaust gas passages whose upstream ends are opened and downstream ends are closed. Microporous walls formed with numerous holes are provided between adjacent passages. Particulates contained in the exhaust gas are captured in these holes.

A NOx catalytic converter (shown in the figure as “LNC”) 52 is installed in the exhaust pipe 40 at a position downstream of the filter 50 to adsorb and reduce the pollutant of NOx in the exhaust gas.

After passing through the NOx catalytic converter 52, the exhaust gas passes through a silencer, tailpipe and the like (none of which are shown) to be discharged to outside of the engine 10.

A crank angle sensor 54 including multiple sets of magnetic pickups is installed near the crankshaft 32 of the engine 10. The crank angle sensor 54 produces outputs indicative of a cylinder identification signal, a TDC signal at or near the TDC of each of the four cylinders, and a crank angle signal every prescribed crank angle.

An airflow meter 56 equipped with a temperature detection element is installed in the intake pipe 14 at a point near the air cleaner 12 and produces an output or signal indicative of the flow rate of (intake) air sucked through the air cleaner 12, i.e., the engine load. A manifold pressure sensor 60 is installed at a location downstream of the intake shutter 16 and produces an output or signal indicative of the manifold pressure, i.e. the engine load. A coolant temperature sensor 62 is installed near a coolant passage (not shown) of the engine main body 10a and produces an output or signal indicative of the engine coolant temperature TW.

An accelerator position sensor 66 is installed near an accelerator pedal 64 located on the floor near the driver's seat (not shown) of the vehicle in which the engine 10 is installed. The accelerator position sensor 66 produces an output or signal indicative of the accelerator position or opening AP, which is indicative of the engine load.

A clutch switch 72 is installed near a clutch pedal 70 and produces an ON signal when the clutch pedal 70 is depressed by the driver. A wheel speed sensor 74 is installed at a suitable part of each driven and free wheels (not shown) and produces an output or signal at every predetermined angle of rotation of the wheel indicative of a travel speed of the vehicle.

An UEGO (Universal Exhaust Gas Oxygen) sensor 76 is installed in the exhaust pipe 40 at a location upstream of the three-way catalytic converter 46 and produces an output or signal indicative of the air/fuel ratio of exhaust gas.

A first exhaust gas temperature sensor 80 is installed in the exhaust pipe 40 at that location and produces an output or signal indicative of the exhaust gas temperature at the position upstream of the three-way catalytic converter 46.

A second exhaust gas temperature sensor 82 is installed in the exhaust pipe 40 at a position downstream of the filter 50 and upstream of the NOx catalytic converter 52 and produces an output or signal indicative of the exhaust gas temperature at the position upstream of the NOx catalytic converter 52.

The filter 50 is provided with a differential pressure sensor 84 that produces an output or signal indicative of the differential pressure between the pressures of the exhaust gas flowing into and flowing out of the filter, i.e., the differential pressure between the inlet side and outlet side pressures of the filter 50.

An oil level sensor 86 is installed at the bottom of the oil pan 34 and produces an output or signal indicative of the level of the engine oil EO (the liquid level of the engine oil EO) pooled there. The oil level sensor 86 is a detector that utilizes a principle that heat discharge changes depending on the magnitude or level of the engine oil. Specifically, it has a heater element such as a resistor to raise the oil temperature to a certain degree, e.g., 10 degrees and a time measurement device to measure elapse of time until the temperature drops by a certain degree, e.g., 5 degrees, and produces an output proportional to the oil level from the measured time. A temperature sensor 88 is installed near the oil level sensor 86 and produces an output or signal indicative of the temperature of the engine oil EO.

The outputs of the foregoing sensors are sent to the ECU (now assigned reference numeral 90). For the brevity of illustration, signal lines between the ECU 90 and the sensors or the injectors 24 are omitted.

The ECU 90 is constituted as a microcomputer comprising a CPU, ROM, RAM and input/output circuit and an EEPROM (nonvolatile memory) 92, and has a warning lamp 94. The data of the EEPROM 92 is kept stored after the engine 10 is stopped.

The ECU 90 detects or calculates the engine speed NE of the engine 10 by using a counter to count the crank angle signals outputted by the crank angle sensor 54 and detects or calculates the vehicle speed V by using a counter to count the signals outputted by the wheel speed sensor 74.

The ECU 90 calculates the amount of fuel injection based on the calculated engine speed NE and outputs of the other sensors and controls operation of the engine 10 by injecting fuel of the amount into the combustion chambers through the injectors 24.

Further, when it is determined from the output of the differential pressure sensor 84 that the particulates captured and deposited on the filter 50 exceed a threshold value and hence regeneration of the filter 50 is necessary, and when the engine 10 is at low or middle load, the ECU 90 conducts post fuel injection at or near the exhaust stroke, more specifically at a time point when the engine event is being shifted from expansion to exhaust stroke. The post injected fuel flows to the exhaust system and arrives at the three-way catalytic converter 46 where oxidation reaction (combustion) takes place. The exhaust gas heated by this combustion flows to the downstream filter 50 and burns off the particulates deposited on the filter 50 to regenerate the filter 50.

Furthermore, the ECU 90 detects the level (liquid level or magnitude) of the engine oil EO.

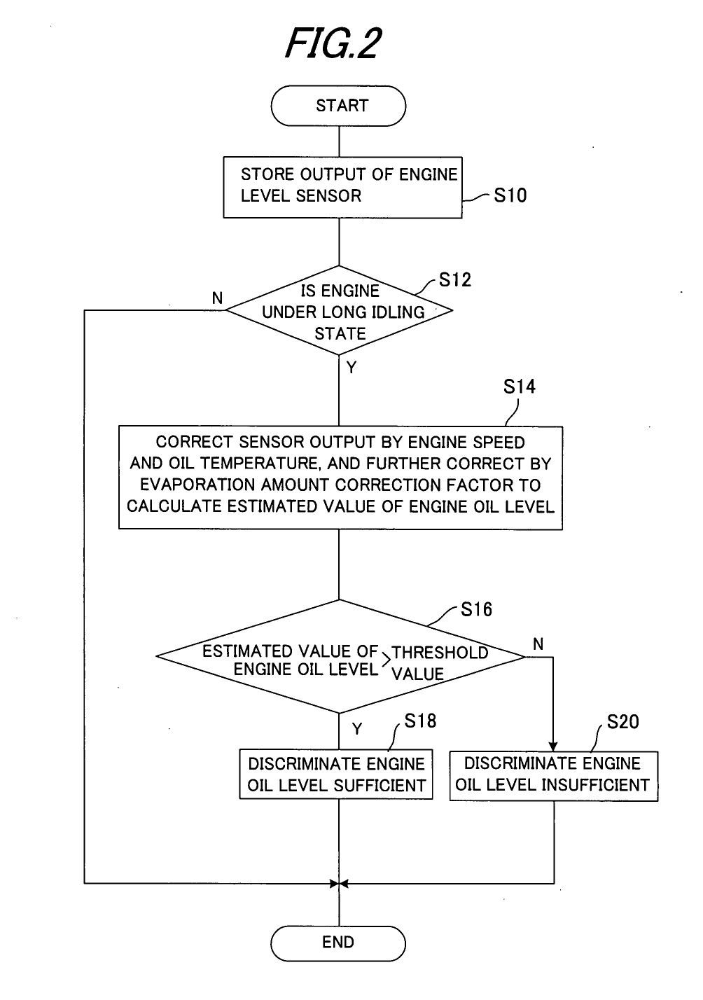

FIG. 2 is a flowchart showing the engine oil level detection conducted by the ECU 90.

The program begins in S10 in which the output of the oil level sensor 86 is read and is stored or memorized in RAM or EEPROM 92.

The program proceeds to S12 in which it is determined whether the engine 10 is under a long idling state in which an idling state continues for a predetermined period of time or more. The long idling state indicates a state (in which the engine speed NE is within a predetermined range (e.g., a range from 600 rpm to 1000 rpm) and the vehicle speed V is less than a predetermined speed (e.g., 3 km/h)) that is kept for a predetermined period of time or more and in addition, a prescribed period of time or more has passed since depression of the clutch pedal 70 (since driver's manipulation of the manual transmission clutch).

When these conditions are met, it is determined that the engine 10 is under the long idling state. After the state was once determined, however, if the engine speed NE becomes out of the range, or if the vehicle speed V exceeds the predetermined speed, or the clutch pedal 70 is again depressed, since it indicates that the vehicle starts to run, the long idling state determination is canceled.

When the result in S12 is negative, the program skips following steps. On the other hand, when the result in S112 is affirmative and the engine 10 is determined to be under the long idling state, the program proceeds to S14 in which the stored output of the oil level sensor 86 is corrected by the detected engine speed NE and the temperature of the engine oil EO. Then the corrected output of the oil level sensor 86 is multiplied by an evaporation amount correction factor (multiplication factor) to conduct fuel evaporation amount correction.

These corrections amounts to calculating an estimated value of the level of the engine oil EO, i.e., an estimated value of the engine oil level under the long idling state.

Once again referring to the object of the present invention, in the diesel engine 10, a post fuel injection is carried out at or near the exhaust stroke to burn off the particulates deposited on the filter 50 and regenerate it. However, a part of fuel of the post injection collects in the oil pan 34 and mixes with the engine oil EO to dilute it. Although the level of engine oil EO increases apparently, the mixed fuel component will evaporate shortly. This may sometimes delay the detection of oil shortage. Evaporation of mixed fuel is promoted when the engine runs at idle speed consecutively for a long period of time. The object of the present invention is to detect the oil shortage without delay even when the engine runs at idle speed consecutively for a long period of time.

The evaporation amount (or volume) of the engine oil EO is influenced by its temperature. Since the characteristics of this engine oil temperature differs depending on different engine displacement (capacity or swept volume) and different oil pan shape, in this embodiment, the evaporation amount correction factor is a factor that estimates evaporation amount of fuel mixed in the engine oil and is preset beforehand based on at least one, more specifically both of the displacement of the engine 10 and shape of the oil pan 34.

In S14, as mentioned above, the corrected output of the oil level sensor 86 is multiplied by the preset evaporation amount correction factor and the resultant product is treated as the estimated value of the engine oil level under the long idling state.

The program then proceeds to S16 in which the calculated estimated value of the engine oil level is compared with a threshold value to determine whether the estimated value of the engine oil level is greater than the threshold value.

When the result in S16 is affirmative, the program proceeds to S118 in which the level of the engine oil EO is discriminated to be sufficient. When the result in S116 is negative, the program proceeds to S20 in which the level of the engine oil EO is discriminated to be insufficient and at the same time, the warning lamp 94 is turned on to alert it to the driver.

As stated above, the embodiment is configured to have a system for detecting level of engine oil (EO) in an oil pan (34) of an internal combustion engine (10) having a filter (DPF 50) to capture particulates in exhaust gas that is burned off by fuel supplied by post injection to be regenerated, comprising an oil level sensor (86) installed in the oil pan and adapted to produce an output indicative of the engine oil level; a long idling state determiner (90, S12) that determines whether the engine is under a long idling state in which an idling state continues for a predetermined period of time or more; an estimated engine oil level calculator (90, S14) that calculates an estimated value of the engine oil level under the long idling state by correcting the output of the oil level sensor by an evaporation amount correction factor, when the engine is determined to be under the long idling state; and an engine oil level discriminator (90, S16 to S20) that discriminates whether the level of the engine oil is sufficient based on the calculated estimated value of the engine oil level.

Thus, since the engine oil level under the long idling state is estimated and the engine oil level is determined to be sufficient or not, it becomes possible to detect the change of the engine oil level due to evaporation of the mixed fuel during the long idling state. With this, even under the long idling state in which evaporation of the mixed fuel is promoted, it becomes possible to detect the oil shortage without delay.

In the system, the evaporation amount correction factor is set based on at least one, more specifically both of displacement of the engine and shape of the oil pan. The oil temperature influences on the oil dilution or oil volume. However, with this, it becomes possible to determine the evaporation amount correction factor accurately.

In the system, the estimated engine oil level calculator corrects the output of the oil level sensor by engine speed NE and temperature of the engine oil and further corrects the corrected output of the oil level sensor by the evaporation amount correction factor to calculate the estimated value of the engine oil level (S90, S114).

In the system, the engine oil level discriminator compares the calculated estimated value of the engine oil level with a threshold value (90, S16) and discriminates that the level of the engine oil is sufficient when the calculated estimated value of the engine oil level is greater than the threshold value (90, S18).

In the system, the engine oil level discriminator turns on a warning lamp (94) when the level of the engine oil is discriminated to be insufficient (90, S20).

It should be noted in the above that the disclosed structure of the exhaust system is an example and should not be limited thereto. It suffices if the filter (DPF) 50 is installed in the exhaust system.

It should further be noted that, although the foregoing explanation is made taking application of the invention to a vehicle engine as an example, the invention can also be applied to an engine for a boat propulsion system such as an outboard motor having a vertically oriented crankshaft.

Japanese Patent Application No. 2006-236935 filed on Aug. 31, 2006, is incorporated herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A system for detecting level of engine oil in an oil pan of an internal combustion engine having a filter to capture particulates in exhaust gas that is burned off by fuel supplied by post injection to be regenerated, comprising:
an oil level sensor installed in the oil pan and adapted to produce an output indicative of the engine oil level;
a long idling state determiner that determines whether the engine is under a long idling state in which an idling state continues for a predetermined period of time or more;
an estimated engine oil level calculator that calculates an estimated value of the engine oil level under the long idling state by correcting the output of the oil level sensor by an evaporation amount correction factor, when the engine is determined to be under the long idling state; and
an engine oil level discriminator that discriminates whether the level of the engine oil is sufficient based on the calculated estimated value of the engine oil level.

2. The system according to claim 1, wherein the evaporation amount correction factor is set based on at least one of displacement of the engine and shape of the oil pan.

3. The system according to claim 1, wherein the estimated engine oil level calculator corrects the output of the oil level sensor by engine speed and temperature of the engine oil and further corrects the corrected output of the oil level sensor by the evaporation amount correction factor to calculate the estimated value of the engine oil level.

4. The system according to claim 1, wherein the engine oil level discriminator compares the calculated estimated value of the engine oil level with a threshold value and discriminates that the level of the engine oil is sufficient when the calculated estimated value of the engine oil level is greater than the threshold value.

5. The system according to claim 1, wherein the engine oil level discriminator turns on a warning lamp when the level of the engine oil is discriminated to be insufficient.

6. A method of detecting level of engine oil in an oil pan of an internal combustion engine having a filter to capture particulates in exhaust gas that is burned off by fuel supplied by post injection to be regenerated and an oil level sensor installed in the oil pan and adapted to produce an output indicative of the engine oil level, comprising the steps of;
determining whether the engine is under a long idling state in which an idling state continues for a predetermined period of time or more;
calculating an estimated value of the engine oil level under the long idling state by correcting the output of the oil level sensor by an evaporation amount correction factor, when the engine is determined to be under the long idling state; and
discriminating whether the level of the engine oil is sufficient based on the calculated estimated value of the engine oil level.

7. The method according to claim 6, wherein the evaporation amount correction factor is set based on at least one of displacement of the engine and shape of the oil pan.

8. The method according to claim 6, wherein the step of estimated engine oil level calculating corrects the output of the oil level sensor by engine speed and temperature of the engine oil and further corrects the corrected output of the oil level sensor by the evaporation amount correction factor to calculate the estimated value of the engine oil level.

9. The method according to claim 6, wherein the step of engine oil level discriminating compares the calculated estimated value of the engine oil level with a threshold value and discriminates that the level of the engine oil is sufficient when the calculated estimated value of the engine oil level is greater than the threshold value.

10. The method according to claim 6, wherein the step of engine oil level discriminating turns on a warning lamp when the level of the engine oil is discriminated to be insufficient.
